(19) United States
(12) Patent Application Publication
(10) Pub. No.: US 2026/0153126 A1
(43) Pub. Date: Jun. 4, 2026

(54) SEALING DEVICE FOR A ROLLING BEARING AND ASSOCIATED ROLLING BEARING

(71) Applicant: Aktiebolaget SKF, Goteborg (SE)

(72) Inventors: Riccardo RESTIVO, Torino (IT); Piero SANTANGELO, Torino (IT); Mauro MIOTTO, Nichelino (IT); Giuseppe GRASSI, Pinerolo (IT)

(73) Assignee: Aktiebolaget SKF, Goteborg (SE)

(21) Appl. No.: 19/396,977

(22) Filed: Nov. 21, 2025

(30) Foreign Application Priority Data
Dec. 3, 2024 (IT) 102024000027393

(51) Int. Cl. F16C 33/78

(52) U.S. Cl. CPC F16C 33/7823

(57) ABSTRACT

A sealing device (5) for a rolling bearing (1) includes an annular support (8) and an elastomeric element (9) integral with the annular support. A radially outer edge (10) of the elastomeric element mates with an outer ring (2). A radially inner edge (11) of the elastomeric element mates with a shoulder surface (15) of an annular sealing seat (13) of the inner ring (3). An annular sealing lip (20) shaped substantially in the form of a sleeve axially protrudes only from a front face (21) directed towards the inside of the bearing (1) of a flange-shaped radial arm (16). The radial arm radially protrudes with respect to the annular support (8) from a root portion (22) of the radially inner edge. The elastomeric element has an axial overhang (24) which protrudes from the front face along an axial extension approximately equal to that of the annular sealing lip.

### CROSS-REFERENCE TO RELATED APPLICATION

This application claims priority to Italian Patent Application No. 102024000027393, filed Dec. 3, 2024, the entirety of which is hereby incorporated by reference.

### FIELD

The present disclosure relates to an improved sliding-sealing device for a rolling bearing, able to exert a small amount of friction substantially irrespective as to the interference which occurs during use between a sliding lip of the sealing device and a bearing ring. The present disclosure also relates to an associated rolling bearing.

### BACKGROUND

A sealing device for a rolling bearing configured to exert an axial sealing action on a shoulder surface of an annular sealing seat formed in a radially outer side surface of an inner ring of the rolling bearing is known.

The sealing device consists of a generally metallic annular support which has, integral therewith, an elastomeric annular sealing element, which has a radially outer edge projecting radially protruding from the annular support and configured to snap-engage in a fluid-tight manner with an outer ring of the rolling bearing, and a radially inner edge configured to be inserted in the said annular sealing seat of the inner ring and consisting of a radial arm, formed as an annular flange projecting radially protruding from the annular support, but on the opposite side to the radially outer edge, and an annular end portion of the radial arm, substantially formed as a hammer head and configured to cooperate axially in contact and with interference with the shoulder surface of the sealing seat, so as to protect the bearing from external contamination.

For this purpose, an average interference of about 0.3 mm is calculated for design purposes. However, there exist conditions in which said interference may be negligible or may be too high, resulting in a very high degree of friction. This means that the performance may vary greatly from one bearing to another and may be poor in certain conditions.

In particular, the interference values at present may vary from a minimum of 0.05 mm to a maximum of 0.55-0.6 mm. Within this range the performance level may vary greatly, being poor when the interference is at a minimum and, on the contrary, resulting in a very high degree of friction when the interference is at its maximum level. When the sealing device works under conditions where an angular misalignment is present, there is also the possibility that the sliding portion shaped as a hammer head does not make contact with the shoulder surface on the inner ring, at least in certain points.

This is sufficient to cause a significant worsening of the sealing function.

### SUMMARY

The object of the present disclosure is to provide an improved sealing device for a rolling bearing of the type described, but which does not have the aforementioned drawbacks.

It is also an object of the present disclosure to provide an associated rolling bearing equipped with such an improved sealing device.

According to the present disclosure an improved sealing device for a rolling bearing and an associated rolling bearing having the characteristic features described in the attached claims are provided.

The present disclosure is based on a novel design with an axial sealing lip which replaces the annular end portion of the radial arm and which allows a wider interference range, while also ensuring that the sealing lip remains always in contact in any conditions and with a smaller amount of friction.

### BRIEF DESCRIPTION OF THE DRAWINGS

The present disclosure will now be described with reference to the accompanying drawings which illustrate some non-limiting examples of embodiment thereof, in which:

FIG. 1 shows in schematic form a radially sectioned partial view of a rolling bearing according to the present disclosure provided with the improved sealing device according to the present disclosure;

FIG. 2 shows in schematic form on a larger scale a radially sectioned view of a radially inner portion of the improved sealing device according to the present disclosure;

FIG. 3 shows in schematic form a further enlarged detail of the improved sealing device according to the present disclosure;

FIG. 4 shows in schematic form an enlarged detail of FIG. 1 highlighting a detail of the sealing device according to the present disclosure; and

FIGS. 5 and 6 show on a larger scale and with a greater amount of detail a same radially inner portion of two possible embodiments of the sealing device according to the present disclosure applied to a different embodiment of the rolling bearing according to the present disclosure.

### DETAILED DESCRIPTION

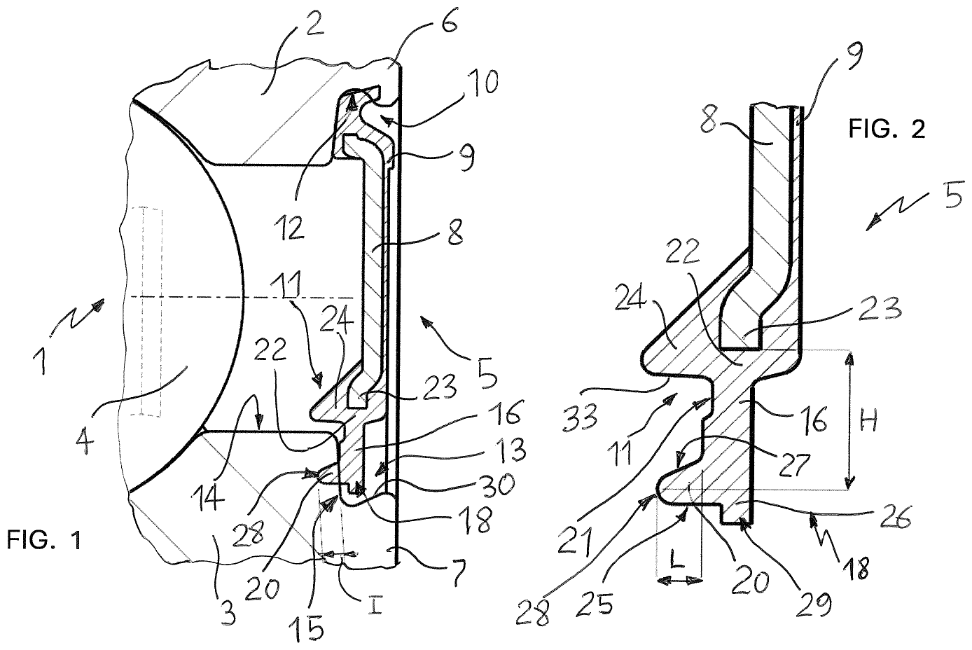

With reference to FIGS. 1 to 4, 1 denotes overall a rolling bearing comprising an outer ring 2, an inner ring 3, a plurality of rolling bodies 4 interposed between the inner ring 3 and the outer ring 2 such that they are relatively rotatable with a small degree of friction, and at least one sealing device 5 arranged between the rings 2 and 3 so as to protect the inside of the rolling bearing 1 defined by the annular space bounded between the rings 2 and 3 and housing the rolling bodies 4.

The rolling bearing 1 may be of any type, with one or two rows of rolling bodies, which may be defined by balls, as in the non-limiting example described, or conical or cylindrical rollers.

The sealing device 5 is arranged at the axial opposite ends (only one of which shown, the bearing 1 being symmetrical), i.e. the end 6 of the outer ring 2 and the end 7 of the inner ring 3.

The sealing device 5 comprises a substantially rigid annular support 8 which is preferably metallic and an elastomeric sealing element 9 constrained integrally, in a known manner, to the annular support 8 and in turn comprising a radially outer peripheral edge 10 coupled in a fluid-tight manner with the outer ring 2, and a radially inner peripheral edge 11 exerting a sliding sealing action on the inner ring 3.

In the non-limiting example shown, the end 6 is provided with an annular seat 12 which receives, snap-engaged in a fluid-tight manner, the radially outer peripheral edge 10 of the sealing device 5 which is thus coupled angularly integrally to the outer ring 2. Any other known method of coupling to the outer ring 2 is also possible.

According to one aspect of the present disclosure, each end 7 of the inner ring 3 configured to cooperate with the sealing device 5 is provided with an annular sealing seat 13 formed on a radially outer side surface 14 of the inner ring 3 so as to define on the end 7 an annular step comprising a radially oriented shoulder surface 15 on which the radially inner edge 11 of the elastomeric sealing element 9 exerts, in the manner which will be described below, an axial sealing action inside the annular sealing seat 13.

The elastomeric sealing element 9 of the sealing device 5 is therefore bounded radially by the two opposite peripheral edges 10 and 11, the first one being configured to mate, in a fluid-tight manner, with the outer ring 2 of the rolling bearing 1 and the second one exerting, during use, an axial sealing action on the shoulder surface 15 of the annular sealing seat 13 formed on the outer side surface 14 of the ring 3.

Both the radially outer peripheral edge 10 and the radially inner peripheral edge 11 extend radially protruding from the annular support 8 so as not to be stiffened by the latter and therefore be free to be elastically deformed.

In particular, the radially inner edge 11 of the elastomeric sealing element 9 comprises, viewed in radial cross-section, an arm 16 formed as an annular flange and projecting radially protruding from the annular support 8, on the opposite side to the radially outer edge 10, and a peripherally and radially more inner-lying annular end portion 18 (FIG. 1) configured to be inserted during use inside the sealing seat 13 and to cooperate in contact with the shoulder surface 15.

According to a first aspect of the present disclosure, the annular end portion 18 includes at least one annular sealing lip 20 shaped substantially as a sleeve and configured to mate with axial interference I (FIGS. 1 and 4) with the shoulder surface 15.

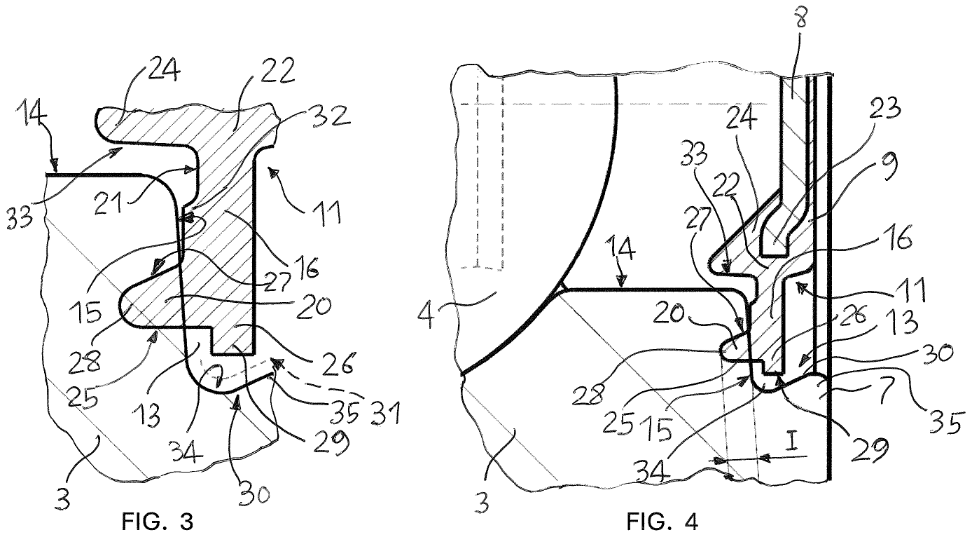

In particular, the sleeve-shaped annular lip 20 projects axially protruding from a first front face 21 (FIGS. 3, 5 and 6) of the flange-shaped radial arm 16. The front face 21 is directed during use towards the inside of the rolling bearing 1 and therefore the side where the rolling bodies 4 are located.

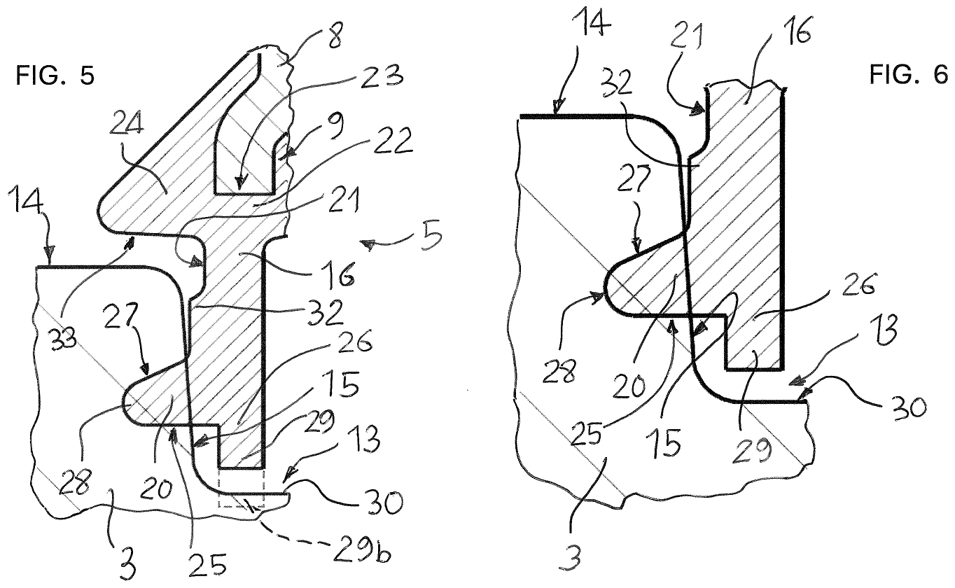

The radially inner edge 11 of the elastomeric element 9 further comprises an annular root portion 22 (see also FIGS. 5 and 6) in which a radially inner peripheral edge 23 of the annular support 8 is embedded.

The flange-shaped radial arm 16 extends protruding from the root portion 22, radially spaced from the radially inner peripheral space 23 of the annular support 8 by means of the root portion 22 itself. Moreover, the flange-shaped radial arm 16 is formed so as to be arranged axially misaligned with respect to the edge 23 on the side where the sleeve-shaped annular lip 20 is located, even if only by a fraction of the axial thickness of the said flange-shaped radial arm 16.

The root portion 22 also comprises an axial overhang 24 which extends protruding therefrom on the side of the first face 21 and, according to an aspect of the present disclosure, the sleeve-shaped annular lip 20 has an axially protruding extension comparable to that of the axial overhang 24. “Comparable to” is understood here and below as meaning “similar to” or “of the same order of magnitude as”; in particular, the lip 20 extends protruding by an amount slightly less than that of the overhang 24 where “slightly less than” indicates a decimal fraction of the axial extension of the overhang 24.

The sleeve-shaped annular lip 20 is bounded between a substantially cylindrical radially inner side surface 25 thereof, arranged substantially flush with a terminal end 26 of the flange-shaped radial arm 16, and a substantially conical radially outer side surface 27 thereof, converging towards the substantially cylindrical radially inner surface 25 so as to connect with it by means of a free rounded end of the annular sleeve-shaped lip 20 defining an annular sealing edge 28 of the sleeve-shaped annular lip 20.

According to a preferred embodiment of the present disclosure, the axially protruding length L of the sleeve-shaped annular lip 20 is equal to about ⅓rd of the radial distance H of the annular sealing edge 28 from the radially inner peripheral edge 23 of the annular support 8 (FIG. 2).

In particular the ratio L:H is between 0.3 and 0.4.

The radially protruding extension of the flange-shaped radial arm 16 may be equal to about ⅕th of a radial distance between the radially outer peripheral edge 10 and the radially inner peripheral edge 11 of the elastomeric sealing element 9.

Preferably the ratio of the radially protruding extension of the flange-shaped radial arm 16 to the radial distance between the radially outer peripheral edge 10 and the radially inner peripheral edge 11 of the elastomeric sealing element 9 is between 0.15 and 0.35.

The annular end portion 18 of the flange-shaped radial arm 16 comprises, according to another aspect of the present disclosure, a second sealing lip 29, which extends in only the radial direction from the terminal end 26 of the flange-shaped radial arm 16, radially on the inside of the sleeve-shaped annular lip 20.

The second sealing lip 29 is configured to cooperate, during use, with a radially outer side surface 30 of the sealing seat 13 and is formed as an annular relief having a substantially rectangular shape in radial cross-section and an axial thickness smaller than that of the flange-shaped radial arm 16.

According to the embodiment shown in solid lines in FIGS. 3, 4, 5 and 6, the second sealing lip 29 is configured as a non-contacting lip configured to form, during use, together with the radially outer side surface 30 of the sealing seat 13, a labyrinth seal 31, shown schematically in FIG. 3 in broken lines.

According to the embodiment shown schematically in broken lines in FIG. 5 alone, the second sealing lip 29 is configured as a contacting lip 29b, configured to form, during use, a sliding seal on the radially outer side surface 30 of the sealing seat 13, having a radial length sufficient to allow mating with an interference fit with the surface 30.

According to another aspect of the present disclosure, the flange-shaped radial arm 16 is also provided with an axially thicker part 32 (FIGS. 3, 5 and 6) arranged immediately adjacent to the sleeve-shaped annular lip 20, radially on the outside thereof.

The axially thicker part 32 is also formed so as to be radially spaced from the annular root portion 22 of the radially inner edge 11 of the elastomeric sealing element 9 in which the radially inner peripheral edge 23 of the annular support 8 is embedded.

This thicker part 32 has proved to be useful for preventing damage, as a result of cutting, of the flange-shaped radial arm 16 due to its radial length which is greater than that of similar sealing devices of the prior art, in which moreover the lip 20 is absent, while only the hammer-head shaped annular end portion 18 is present.

From the above description it can be understood that the present disclosure is not limited to the sealing device 5 alone, but also includes the above-described rolling bearing 1 which is equipped with the sealing device 5 and in which the axial overhang 24:
extends protruding from the root portion 22 on the side of the face 21 of the flange-shaped radial arm 16 which is directed towards the rolling bodies 4; and
is bounded radially on the inside by a side surface 33 arranged facing and substantially parallel to the radially outer side surface 14 of the inner ring 3.

Furthermore, the flange-shaped radial arm 16 has, mounted thereon axially protruding, the sleeve-shaped annular sealing lip 20 only on the side of the front face 21 and along an axial extension similar to that of the axial overhang 24, so as to come into axial abutment against the shoulder surface 15 of the annular sealing seat 13, with which it cooperates by means of sliding with a radial interference ranging, according to an aspect of the present disclosure, between 0.2 and 0.7 mm, where the flange-shaped arm 16 and the sleeve-shaped lip 20 have dimensions such that the interference never falls below 0.2 mm even in the presence of misalignment of the inner ring 3 and outer ring 2.

The second sealing lip 29, which extends only in the radial direction from the terminal end 26 of the flange-shaped radial arm 16, radially on the inside of the annular lip 20 cooperates with the radially outer side surface 30 of the sealing seat 13, coupled in a non-contacting manner, so as to define the labyrinth seal 31, or in a contacting manner, so as to define a radial sliding seal.

According to one aspect of the present disclosure, the radially outer side surface 30 of the sealing seat 13 is formed, in a first embodiment, as a cylindrical surface (FIGS. 5 and 6) or as a wave-shaped surface (FIGS. 1, 3 and 4) comprising a first section, adjacent to the shoulder surface 15, defined by an annular recess 34 rounded in cross-section, and a second section, adjacent to the terminal end 7 of the inner ring 3, defined by an annular relief 35 rounded in radial cross-section.

According to this embodiment, the second sealing lip 29 engages with the inside of the annular recess 34, in particular so as to define therewith the labyrinth seal 31 (FIG. 3).

Finally, the flange-shaped radial arm 16 is provided with an axially thicker part 32 on the side facing the rolling bodies 4 and radially spaced from the annular root portion 22 of the radially inner edge 11 of the elastomeric sealing element 9 by a radial amount substantially comparable to the radial extension of the axially thicker part 32 itself.

The novel design described here of the sealing device 5 according to the present disclosure increases the average interference between the axial sealing lip 20 and the shoulder surface 15 of the sealing seat 13 of the inner ring 3 of the bearing 1 up to 0.45 mm. The minimum interference is never less than 0.2 mm with a pressure of the contact lip which is comparable to the best level in the prior art. The maximum interference may reach a value of up to 0.6-0.7 mm, but without a significant increase in the friction.

Within the aforementioned interference range, it is ensured that the lip 20 always remains in contact in any conditions, even taking into account an angular misalignment of the inner ring and outer ring of the bearing.

This has been made possible by an increase, compared to the prior art, of the distance between the radially inner edge 23 of the metallic annular support 8 and the sliding edge of the axial sealing lip 20 and the distance between the sliding edge of the sealing lip 20 and the flange-shaped annular arm 16 which has, mounted thereon integrally as one piece, the axial sealing lip 20.

Owing to the design described, the following advantages are obtained:
Greater average interference with greater associated protection against contamination;
Sealing lip always making contact in any conditions;
Less friction and less influence of the lip interference on the friction level;
Additional lip which increases protection; and
Possibility of selecting a different sealing groove on the inner ring which is easier to produce at a lower cost and with an improved surface quality.

All the objects of the present disclosure are therefore achieved.

What is claimed is:

1. A sealing device for a rolling bearing, the rolling bearing having an outer ring and an inner ring, the inner ring having a radially outer side surface and an annular sealing seat formed on the radially outer side surface, the annular sealing seating having a shoulder surface, the sealing device comprising:
a substantially rigid annular support; and
an elastomeric sealing element constrained integrally to the annular support, the elastomeric sealing element comprising:
a radially outer edge configured to mate in a fluid-tight manner with the outer ring of the rolling bearing; and
a radially inner edge configured to exert an axial sealing action on the shoulder surface of the inner ring of the rolling bearing, the radially inner edge comprising, in radial cross-section:
a flange-shaped radial arm radially protruding from the annular support, on the opposite side to the radially outer edge, the flange-shaped radial arm having a first front face configured to face towards an inside of the rolling bearing; and
an annular end portion configured to be inserted in said sealing seat of the inner ring and to contact the shoulder surface of the inner ring, the annular end portion including a substantially sleeve-shaped annular sealing lip configured to mate with axial interference with said shoulder surface of the inner ring, said sleeve-shaped annular sealing lip axially protruding only from the first front face of the flange-shaped radial arm.

2. The sealing device according to claim 1, wherein said radially inner edge of the elastomeric sealing element comprises an annular root portion, wherein the annular support has a radially inner peripheral edge embedded in the annular root portion, wherein said flange-shaped radial arm protrudes from the annular root portion, the flange-shaped radial arm being radially spaced from the said radially inner peripheral edge of the annular support, the flange-shaped radial arm being axially misaligned with respect to said radially inner peripheral edge of the annular support on the side of said sleeve-shaped annular sealing lip, wherein the elastomeric sealing element includes an axial overhang protruding from the annular root portion on the side of the first face, and wherein the sleeve-shaped annular sealing lip has an axial extension comparable to that of the axial overhang.

3. The sealing device according to claim 2, wherein said flange-shaped radial arm has a terminal end, wherein said sleeve-shaped annular sealing lip includes a substantially cylindrical radially inner side surface, a substantially conical radially outer side surface, and a free rounded end defining an annular sealing edge, the radially inner side surface of the sleeve-shaped annular sealing lip being arranged substantially flush with the terminal end of the flange-shaped radial arm, the radially outer side surface of the sleeve-shaped annular sealing lip converging towards the radially inner side surface of the sleeve-shaped annular sealing lip, the radially outer and inner side surfaces of the sleeve-shaped annular sealing lip being connected by the free rounded end, the sleeve-shaped annular sealing lip being bounded by the radially outer and inner side surfaces of the sleeve-shaped annular sealing lip, wherein the ratio of an axially protruding length of the sleeve-shaped annular sealing lip to a radial distance of the annular sealing edge from the said radially inner peripheral edge of the annular support is between 0.3 and 0.4.

4. The sealing device according to claim 1, wherein a ratio of the radially protruding extension of the said flange-shaped radial arm to a radial distance between the radially outer peripheral edge and the radially inner peripheral edge of the elastomeric sealing element is between 0.15 and 0.35.

5. The sealing device according to claim 1, wherein said flange-shaped radial arm has a terminal end radially on the inside of said sleeve-shaped annular sealing lip, wherein said annular end portion of the flange-shaped radial arm comprises a second sealing lip extending only in a radial direction from the terminal end, wherein the sealing seat comprises a radially outer side surface, said second sealing lip being configured to cooperate during use with the radially outer side surface, said second sealing lip being formed as an annular rib having in radial cross-section a substantially rectangular shape and an axial thickness less than that of the flange-shaped radial arm.

6. The sealing device according to claim 5, wherein said second sealing lip is configured either as:
a non-contacting lip configured to form, during use, a labyrinth seal with said radially outer side surface of the sealing seat; or
a contacting lip configured to form, during use, a seal sliding on said radially outer side surface of the sealing seat.

7. The sealing device according to claim 1, wherein said flange-shaped radial arm has an axially thicker part arranged immediately adjacent to said sleeve-shaped annular sealing lip, radially on the outside of said sleeve-shaped annular sealing lip, wherein said radially inner edge of the elastomeric sealing element comprises an annular root portion, the annular support having a radially inner peripheral edge embedded in the annular root portion, wherein said axially thicker part is radially spaced from the annular root portion.

8. The sealing device according to claim 3, wherein a ratio of the radially protruding extension of the said flange-shaped radial arm to a radial distance between the radially outer peripheral edge and the radially inner peripheral edge of the elastomeric sealing element is between 0.15 and 0.35.

9. The sealing device according to claim 8, wherein the terminal end of said flange-shaped radial arm is radially on the inside of said sleeve-shaped annular sealing lip, wherein said annular end portion of the flange-shaped radial arm comprises a second sealing lip extending only in a radial direction from the terminal end, wherein the sealing seat comprises a radially outer side surface, said second sealing lip being configured to cooperate during use with the radially outer side surface, said second sealing lip being formed as an annular rib having in radial cross-section a substantially rectangular shape and an axial thickness less than that of the flange-shaped radial arm.

10. The sealing device according to claim 9, wherein said second sealing lip is configured either as:
a non-contacting lip configured to form, during use, a labyrinth seal with said radially outer side surface of the sealing seat; or
a contacting lip configured to form, during use, a seal sliding on said radially outer side surface of the sealing seat.

11. The sealing device according to claim 10, wherein said flange-shaped radial arm has an axially thicker part arranged immediately adjacent to said sleeve-shaped annular sealing lip, radially on the outside of said sleeve-shaped annular sealing lip, wherein said axially thicker part is radially spaced from the annular root portion of the elastomeric sealing element.

12. A rolling bearing comprising:
an outer ring;
an inner ring having a radially outer side surface and an annular sealing seat formed on the radially outer side surface, the annular sealing seating having a shoulder surface;
a plurality of rolling bodies interposed between the inner and outer rings such that the inner and outer rings are relatively rotatable; and
at least one sealing device comprising:
a substantially rigid annular support having a radially inner peripheral edge; and
an elastomeric sealing element constrained integrally to the annular support, the elastomeric sealing element comprising:
a radially outer edge coupled in a fluid tight manner with the outer ring; and
a radially inner edge exerting an axial sealing action on the shoulder surface of the annular sealing seat of the inner ring; the radially inner edge comprising:
an annular root portion, the radially inner peripheral edge of the annular support being embedded in the annular root portion;
a flange-shaped radial arm extending radially from an annular root portion of the radially inner edge of the elastomeric element, the flange-shaped radial arm having a first face facing the rolling elements, the flange-shaped radial arm protruding on an opposite side to the radially outer edge, the flange-shaped radial arm being radially spaced from the radially inner peripheral edge of the annular support by said root portion, and the flange-shaped radial arm being axially misaligned only by a fraction of its axial thickness with respect to the radially inner peripheral edge of the annular support on the side of the first face;
an axial overhang protruding from the annular root portion on the side of said first face, the axial overhang having a side surface radially bounding the axial overhand, the side surface facing and being substantially parallel to said radially outer side surface of the inner ring; and
an annular sleeve-shaped sealing lip axially protruding from the flange-shaped radial arm only on the side of said first face and along an axial extension similar to that of said axial overhang, so as to axially contact the shoulder surface of said annular sealing seat, the annular sleeve-shaped sealing lip and the should surface cooperating in a sliding manner with a radial interference of 0.2 to 0.7 mm.

13. The rolling bearing according to claim 12, wherein:
the radially inner edge of the elastomeric sealing element further comprises a second sealing lip, extending only in a radial direction from a terminal end of the flange-shaped radial arm, radially on the inside of said annular sleeve-shaped lip;
the second sealing lip cooperates with a radially outer side surface of the sealing seat, coupled in a non-contacting manner so as to define a labyrinth seal, or in a contacting manner so as to define a radial sliding seal;
the radially outer side surface of the sealing seat is formed as a cylindrical surface, or as a wavy surface comprising a first section, adjacent to said shoulder surface, defined by an annular recess rounded in radial cross-section, and a second section, adjacent to a terminal end of the inner ring, defined by an annular relief rounded in radial cross-section;
said second sealing lip, in the non-contacting manner, is disposed inside of said annular recess so as to define with said annular recess said labyrinth seal.

14. The rolling bearing according to claim 12, wherein said flange-shaped radial arm of the sealing device is provided with an axially thicker part arranged immediately adjacent to said annular sleeve-shaped lip, radially on the outside thereof, said axially thicker part being radially spaced from the annular root portion of the radially inner edge of the elastomeric sealing element.

15. The rolling bearing according to claim 13, wherein said flange-shaped radial arm of the sealing device is provided with an axially thicker part arranged immediately adjacent to said annular sleeve-shaped lip, radially on the outside thereof, said axially thicker part being radially spaced from the annular root portion of the radially inner edge of the elastomeric sealing element.
